(19) United States
(12) Patent Application Publication
(10) Pub. No.: US 2008/0261555 A1
(43) Pub. Date: Oct. 23, 2008

(54) Intertalk wristband radio frequency identification tag

(76) Inventors: Yung-Chin Chen, Taichung County (TW); Chun-Chi Wang, Pingtung City (TW); Tien-Mu Hsiao, Tainan City (TW)

Correspondence Address: Joe McKinney Muncy, PO Box 1364, Fairfax, VA, 22038-1364, US

(21) Appl. No.: 11/785,521

(22) Filed: Apr. 18, 2007

(51) Int. Cl. H04M 11/04

(52) U.S. Cl. 455/404.1

(57) ABSTRACT

The present invention discloses an intertalk wristband RFID (Radio Frequency Identification) tag, which applies to any type of wireless automatic wristband RFID system and comprises an RFID system, an audio-receiving system, and an audio-outputting system. The present invention utilizes the RFID system to receive and transmits the audio information-bearing signal and the radio frequency signal to implement a bidirectional communication function. Via the bidirectional communication function, the nursed in an emergency can press an intertalk button to talk with the nursing personnel and ask for rescue.

### FIELD OF THE INVENTION

The present invention relates to a wristband radio frequency identification tag, particularly to an intertalk wristband radio frequency identification tag with two-way radio functionality that can simultaneously transmit and receive radio-frequency signal to perform bidirectional communication.

### BACKGROUND OF THE INVENTION

In many countries, the original agricultural society has evolved into an industrial society. In the traditional agricultural society, women play the role of raising children and taking care of the elderly. However, in an industrial society, many women enter the employment market to achieve a dual-income family with the elderly or the patient left lonely and uncared at home.

According to statistics, about 13% of the elderly have the experience of falls. A fall may only result in a slight harm, such as an abrasion or a bruise, which will heal in few days, but may also result in a serious injury, such as a fracture, which needs a surgical operation and rehabilitation. Sometimes, the injured elderly cannot regain the original mobility, which will deeply beset the injured and his family. Besides, illness increases the probability of falls, such as myocardial infraction, pneumonia, urinary-tract infection, etc. Further, once there was a fall, the probability of falling again is very high. If the fall of the elderly is found late, the elderly may have some physical and/or psychological sequelae.

If there is an emergency-informing system, the medical personnel can provide immediate rescue to reduce harm or even save a life in an emergency. Thereby, an irrecoverable damage may be avoided. Further, the family members can thus keep their minds on working without worry.

For the past ten years, the concept of home security has been gradually popularized. The service contents of home security are no more limited to only guards and alarms but have gradually grown to include lock design, induction illumination, intrusion detection, fire alarm, emergency informing, etc. The emergency-informing service may include providing assistance in the cases: medical rescue, harassment or threat to the residence, fire, emergency, and physical discomfort during outgoing.

When the nursed living alone, who may be an elderly or disabled person, falls or slips, he may ask for rescue via a telephone, a mobile phone or an emergency button with a cable. However, if the injured loses his mobility and cannot move, he is unable to inform the related persons; rescue is thus postponed, which may bring about some sequelae or even an irrecoverable result. Besides, a residence should have privacy. Therefore, how to take care of the elderly or the nursed without the appearance of strange security personnel is a topic deserving to be studied.

### SUMMARY OF THE INVENTION

One objective of the present invention is to provide an intertalk wristband radio frequency identification (RFID) tag, which can simultaneously transmit and receive radio-frequency signal to perform bidirectional communication, whereby the nursed in an emergency can presses the intertalk button to communicate with the medical personnel or the nursing personnel and ask for medical rescue.

To achieve the abovementioned objective, the present invention proposes an intertalk wristband radio frequency identification tag, which can apply to any type of wristband radio frequency identification system and comprises the following components: an RFID system; a switch coupled to the RFID system; an audio-receiving system controlled by the switch to receive audio signal and modulate the audio signal into oscillation frequency, which is then transmitted out by the RFID system; and an audio-outputting system controlled by the switch to receive external audio information-bearing signal via the RFID system and demodulate the audio information-bearing signal into audio frequency and display the audio information.

The RFID system further comprises the following components: a microprocessor used to process signal; a memory storing identification information; and a radio frequency module receiving/modulating the signal output by the microprocessor or the memory, receiving/demodulating external signal and transmitting the demodulated signal to the microprocessor or the memory.

The audio-receiving system further comprises the following components: a microphone receiving audio signal; a modulator receiving the audio signal from the microphone and modulating the audio signal into oscillation frequency; and a high-frequency transceiver receiving the oscillation frequency from the modulator and transmitting the oscillation frequency via the RFID system.

The audio-outputting system further comprises the following components: a high-frequency transceiver receiving external audio information-bearing signal via the RFID system; a demodulator plus an audio frequency amplifier demodulating the audio information-bearing signal into audio frequency; and a speaker displaying audio information.

### BRIEF DESCRIPTION OF THE DRAWINGS

FIG. 1 is a block diagram showing the architecture of the intertalk wristband RFID tag according to the present invention.

FIG. 2 is a diagram schematically showing the application of the present invention.

### DETAILED DESCRIPTION OF THE PREFERRED EMBODIMENTS

The technical contents of the present invention will be described in detail with embodiments. It should be noted that the embodiments are only to exemplify the present invention but not to limit the scope of the present invention.

The present invention can apply to any type of wristband radio frequency identification system. The wristband may adopt a hook-and loop fastener design, which has the advantages of simplicity, convenience, and comfort.

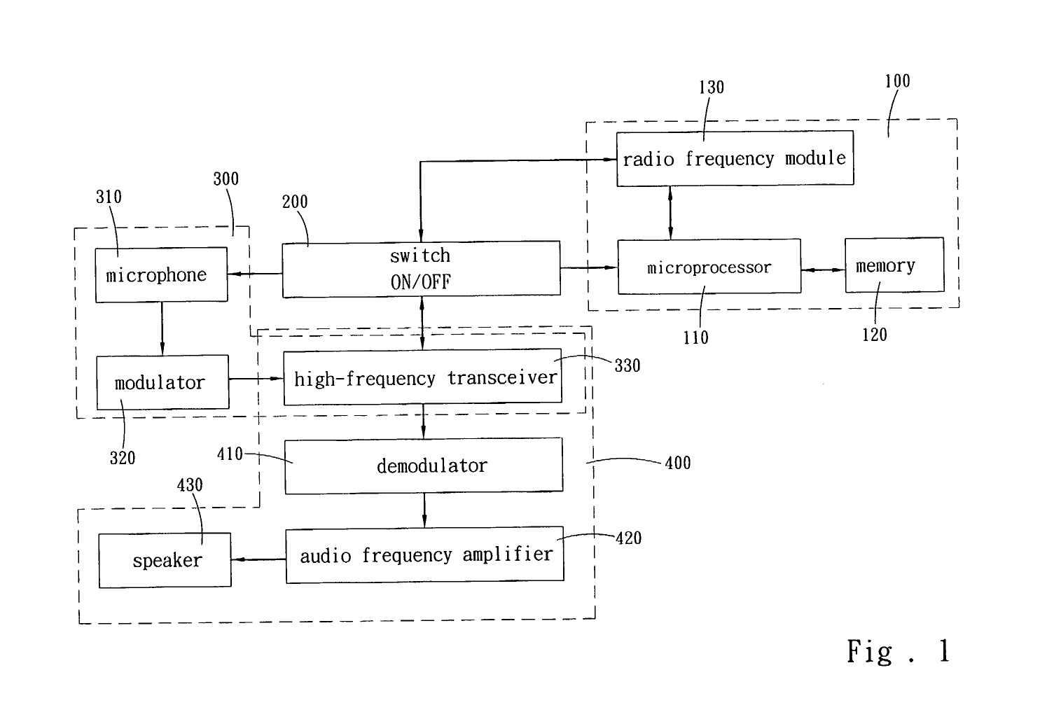

Refer to FIG. 1 a block diagram showing the architecture of the intertalk wristband RFID tag according to the present invention. The present invention comprises the following components: an RFID system 100; a switch 200 coupled to the RFID system 100; an audio-receiving system 300 controlled by the switch 200 to receive audio signal and modulate the audio signal into oscillation frequency, which is then transmitted out by the RFID system 100; and an audio-outputting system 400 controlled by the switch 200 to receive external audio information-bearing signal via the RFID system 100 and demodulate the audio information-bearing signal into audio frequency and display the audio information.

The RFID system 100 further comprises the following components: a microprocessor 110 processing signal, decoding the signal output by an RFID reader, feedbacking data to the reader according to requirements and performing encryption and decryption if the system is an encryption system; a memory 120 storing identification information and implementing the operation of the system ; and a radio frequency module 130 coupled to the microprocessor 110 and the switch 200, receiving and modulating the signal output by the microprocessor 110 or the memory 120, receiving and demodulating external signal, and transmitting the demodulated signal to the microprocessor 110 or the memory 120.

The audio-receiving system 300 further comprises the following components: a microphone 310 receiving audio signal; a modulator 320 receiving the audio signal from the microphone 310 and modulating the audio signal into oscillation frequency; and a high-frequency transceiver 330 receiving the oscillation frequency from the modulator 320 and transmitting the oscillation frequency via the RFID system 100.

The audio-outputting system 400 further comprises the following components: a high-frequency transceiver 330 receiving external audio information-bearing signal via the RFID system 100; a demodulator 410 plus an audio frequency amplifier 420 demodulating the audio information-bearing signal into audio frequency; and a speaker 430 displaying audio information.

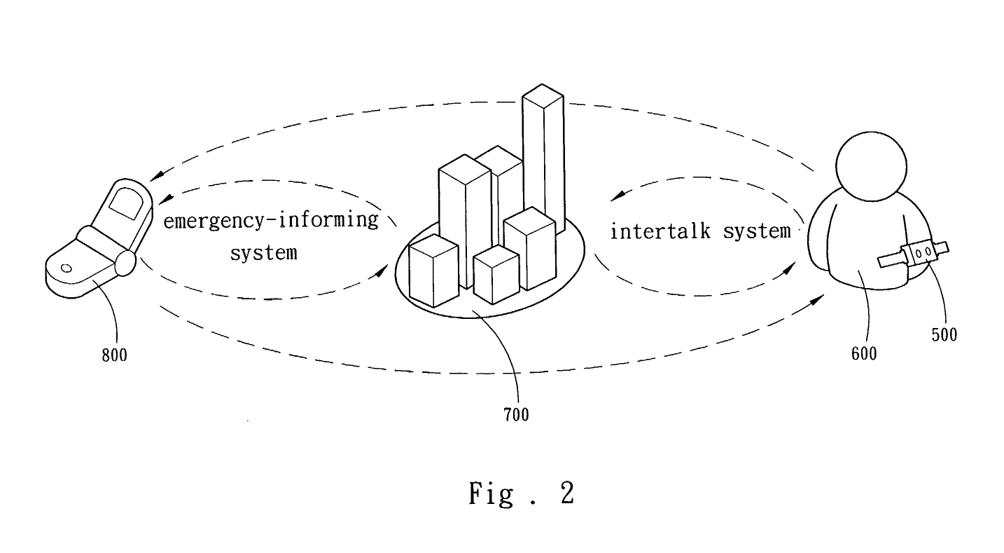

Refer to FIG. 2 a diagram schematically showing the application of the present invention. The RFID tag actively transmits signal to an RF reader. According to the locations of the RF readers, the positions of a wristband RFID tag 500 carried by the nursed 600 are detected and recorded. When the nursed 600 is in an emergency, he can press the switch 200 to turn on the microphone 310 to receive audio signal. The modulator 320 modulates the audio signal into oscillation frequency, and the high-frequency transceiver 330 transmits the oscillation frequency to the radio frequency module 130, and then the radio frequency module 130 sends out the oscillation frequency via its transmitting and receiving antenna. The high-frequency transceiver 330 may also receives external audio information-bearing signal via the transmitting and receiving antenna of the radio frequency module 130. The demodulator 410 plus the audio frequency amplifier 420 demodulate the audio information-bearing signal into audio frequency, and then the speaker 430 displays audio information. When the nursed 600 presses the switch 200, the microprocessor 110 is simultaneously triggered to transmit signal to the reader via the radio frequency module 130 to further trigger the linked host computer, and the host computer further links the SMS (Short Message Service) platform of a telecommunication company via the Internet to send out an SMS 800 to the related persons. Alternatively, the nursing center 700 may also sends out an SMS or a phone call to the related persons via a telecommunication company. The RFID system 100 may also have a dual-color LED. When the voltage of the battery is lower than a predetermined value, the dual-color LED will change its color. The low energy storage status can be sent to the reader via the microprocessor 110 and the transmitting/receiving antenna of the RFID system 100.

In the present invention, an intertalk system, an SMS platform, a 3G real-time video, a network and RFID are integrated to construct the emergency-informing system for the nursed 600. Via RFID, the nursed 600 can be free from piles of cables of the traditional medical monitoring system and moves free. Thus, the mobility limitation of the nursed 600 can be reduced to the minimum with the monitoring function still full working. According to statistics, most of the nursed 600 still have consciousness after they have fallen over. If the nursed 600 slips or falls at home, he may inform the server database in the nursing center 700 via the wristband RFID tag 500 of the present invention when he still has consciousness, wherein the RFID system 100 transmits radio-frequency signal to the reader, and the active RFID application program informs the server database of the nursing center 700 via a communication network. Thus, the medical personnel can learn the position and status of the nursed 600 via the alarm interface of the monitoring computer, SMS, and the instant bidirectional intertalk system. Then, the nursing personnel can response and act optimally within the shortest period.

The present invention utilizes the wristband RFID tag and the intertalk system to check the status of the nursed 600. When the system detects abnormality, the personnel of the nursing center 700 can utilize the intertalk system to talk with the nursed 600 and learn the status of the nursed 600. Thereby, the number of using video monitoring devices can be reduced. Furthermore, the nursed 600 can express his feelings, thoughts and opinions to the personnel of the nursing center 700 via the system. Therefore, the loneliness of the nursed 600 can be reduced, and the self-respect of the nursed 600 can be protected.

Further, the present invention can cooperate with a database to record the name, age, case history, psychology, equilibrium sense, muscle strength, joint mobility, intelligence, daily habits, adopted rehabilitation aid, and time of falls within the last 3-6 months of the nursed 600 and to observe and record the meal, medicine-taking, and toileting of the nursed 600. According to the record, the nursed 600 can be classified into a high-risk faller, a middle-risk faller or a low-risk faller.

The present invention can monitor the daily living of the nursed 600 and can instantly provide the information of the abnormal status for the family members and the medical personnel. Thereby, the family members and the medical personnel can instantly make a correct decision and provide appropriate medical care to reduce the harm on the nursed 600 and avoid an irrecoverable result. Therefore, the family members needn't pay too much attention on the nursed 600 and can do their work without worry.

Those preferred embodiments described above are only to exemplify the present invention but not to limit the scope of the present invention. Any equivalent modification or variation according to the specification or claims of the present invention is to be also included within the scope of the present invention.

What is claimed is:

1. An intertalk wristband radio frequency identification tag, which applies to a wireless automatic wristband radio frequency identification system and comprises:
a radio frequency identification system;
a switch coupled to said radio frequency identification system;
an audio-receiving system controlled by said switch to receive an audio signal and modulate said audio signal into oscillation frequency, which is then transmitted out by said radio frequency identification system; and
an audio-outputting system controlled by said switch to receive an external audio information-bearing signal via said radio frequency identification system and demodulate said audio information-bearing signal into audio frequency and display audio information.

2. The intertalk wristband radio frequency identification tag according to claim 1, wherein said radio frequency identification system further comprises:
a microprocessor coupled to said switch and processing signal;
a memory coupled to said microprocessor and storing identification information; and
a radio frequency module coupled to said microprocessor and said switch, receiving and modulating a signal output by said microprocessor or said memory, receiving and demodulating an external signal, and transmitting the demodulated signal to said microprocessor or said memory.

3. The intertalk wristband radio frequency identification tag according to claim 1, wherein said audio-receiving system further comprises:
a microphone receiving said audio signal;
a modulator receiving said audio signal from said microphone and modulating said audio signal into oscillation frequency; and
a high-frequency transceiver receiving said oscillation frequency from said modulator and transmitting said oscillation frequency via said radio frequency identification system.

4. The intertalk wristband radio frequency identification tag according to claim 1, wherein said audio-outputting system further comprises:
a high-frequency transceiver receiving said external audio information-bearing signal via said radio frequency identification system;
a demodulator plus an audio frequency amplifier demodulating said audio information-bearing signal into audio frequency; and
a speaker displaying audio information.
